(19) United States
(12) Patent Application Publication
(10) Pub. No.: US 2015/0300757 A1
(43) Pub. Date: Oct. 22, 2015

(54) HEAT EXCHANGER TUBE INSERT

(71) Applicant: Enterex America LLC, Westbrook, CT (US)

(72) Inventor: Jie Yang, Hong Kong (CN)

(21) Appl. No.: 14/638,512

(22) Filed: Mar. 4, 2015

Related U.S. Application Data
(60) Provisional application No. 61/980,606, filed on Apr. 17, 2014.

(51) Int. Cl. F28F 9/013; F28F 1/42; B23K 1/00; B23P 15/26

(52) U.S. Cl. CPC F28F 9/0138; B23P 15/26; F28F 1/42; B23K 1/0012

(57) ABSTRACT

A heat exchanger core including a header and a plurality of tubes, each of the tubes having a tube end secured in an opening in a wall of the header to form a tube-to-header joint, a plurality of outer fins capable of transferring heat between a fluid passing through the plurality of tubes and the exterior of the outer fins, the plurality of outer fins being attached between the plurality of tubes and centered about the midpoint in the length of the tubes, the distance from the ends of the plurality of outer fins to the header being a free-of-fin area, and a plurality of resilient tube inserts having a substantially similar cross-section to the cross-section of the plurality of tubes. Each of the resilient tube inserts is inserted into one or more of the tubes at the tube end and secured in the free-of-fin area for the purpose of increasing the tube strength in the free-of-fin area and where the tube passes through, and is attached to, the header. Each of the resilient tube inserts has an outer cross-section dimension greater than the inner cross-section dimension of each tube prior to insertion to enable the tube inserts to remain in place in the free-of-fin area during assembly of a heat exchanger.

### RELATED APPLICATIONS

This application claims priority to U.S. Application No. 61/980,606, filed on Apr. 17, 2014.

### BACKGROUND OF THE INVENTION

1. Field of the Invention

The present invention relates to heat exchangers and, more particularly, to heat exchangers such as engine cooling radiators, charge air coolers, condensers, and the like, which utilize tube inserts to increase strength in the area of the tube-to-header joint.

2. Description of Related Art

Heat exchangers such as engine cooling radiators, charge air coolers, condensers, and the like, typically consist of an inlet tank (or manifold) and an outlet tank (or manifold); a core section between the tanks with inlet and outlet headers connected to the tanks and with multiple fluid tubes running from the inlet header to the outlet header, with cooling fins attached between the tubes; and structural side pieces, one on each side, connected to the inlet and outlet tanks. These side pieces often provide attachments for mounting the heat exchanger.

Each of the fluid tubes is inserted into an opening in the wall of the inlet and outlet headers, respectively, and sealed to form a tube-to-header joint. During operation of the heat exchanger, the fluid-carrying tubes are subject to repeated expansion and contraction as the tubes are alternately heated and cooled, resulting in great stress in the area of the tube-to-header joints as the expanding and contracting tubes try to move the inlet and outlet headers, which are connected to the inlet and outlet tanks, which are restrained from movement by the structural side pieces.

As a result of the expanding and contracting tubes trying to move the immovable headers and tanks, the number one cause of failure of heat exchangers in service is failure of the outer tube-to-header joints or of the tubes adjacent to these joints. Much design effort has been expended in attempts to solve this problem, with examples including heat exchangers with resilient tube-to-header joints, structural side pieces with expansion joints, blocked end tubes which do not carry heated fluid, headers with flexible overhang (the portion of the header between the tubes and the header support), etc. Some of these approaches work quite well, but all are expensive in material and labor, and frequently result in blocking of tubes which results in reduced heat transfer performance.

Therefore, a need exists for a means to prevent end tube-to-header failures with a minimum expenditure of material and labor, while preserving heat exchanger thermal performance.

### SUMMARY OF THE INVENTION

Bearing in mind the problems and deficiencies of the prior art, it is therefore an object of the present invention to provide a tube insert which may be installed manually or through automation, which provides added strength to a tube in the critical portion of the tube at and adjacent to where it passes through, and is joined to, the header.

It is another object of the present invention to provide a tube insert wherein the thickness of the tube insert can be adjusted to provide the necessary tube and tube joint strength to meet application requirements.

A further object of the invention is to provide a tube insert which is flexible in its application and wherein the tube insert can be applied to the ends of a tube nearest to the structural side pieces or to several tubes, as required to meet service life requirements.

It is yet another object of the present invention to provide a tube insert which requires a negligible amount of additional material over that of a standard heat exchanger.

It is still another object of the present invention to provide a tube insert which results in an almost un-measurable increase in fluid pressure drop through the heat exchanger core and therefore has little or no impact on heat exchanger thermal performance.

It is still another object of the present invention to provide a tube insert which includes a spring feature to allow the tube insert to remain in place during core processing.

It is yet another object of the present invention to provide a tube insert which provides a gradual reduction in tube stiffness at and adjacent to the beginning of the free-of-fin area in order to avoid a stress concentration. The free-of-fin area begins where the support to the tubes from the outer fins ends, and extends to the header.

Still other objects and advantages of the invention will in part be obvious and will in part be apparent from the specification.

The above and other objects, which will be apparent to those skilled in the art, are achieved in the present invention which is directed to a core for a heat exchanger, comprising a header having a wall with a plurality of openings therein and a plurality of spaced-apart tubes having a midpoint and an inner diameter, each of the tubes having a tube end secured in an opening in the wall of the header to form a tube-to-header joint. The core includes a plurality of outer fins attached between the plurality of tubes and centered about the midpoint in the length of the tubes. The outer fins have ends spaced from the tube-to-header joint to form a free-of-fin area extending therebetween. The plurality of outer fins are capable of transferring heat between a fluid passing through the plurality of tubes and the exterior of the outer fins. The core further includes a plurality of resilient tube inserts having a substantially similar cross-section to the cross-section of the plurality of tubes. Each of the resilient tube inserts are inserted into one or more of the tubes at the tube end and secured substantially in the free-of-fin area. Each of the resilient tube inserts has outer dimensions slightly greater than the inner diameter of each tube prior to insertion to enable the tube inserts to remain in place in the free-of-fin area during assembly of a heat exchanger.

The plurality of resilient tube inserts may be comprised of the same material as the plurality of tubes. Each of the plurality of resilient tube inserts may or may not extend substantially past the free-of-fin area in the direction of the midpoint of the tube. Each of the plurality of resilient tube inserts may have a length substantially equal to the distance between the end of the outer fins and the end of the tubes.

Each of the plurality of resilient tube inserts may have a length and a portion of the material comprising the length of the resilient tube insert may be removed beginning at the end of the outer fins and extending in the direction of the midpoint of the tube. Alternatively, each of the resilient tube inserts may include at least one tapered tooth beginning at the end of the outer fins and extending in the direction of the midpoint of the tube.

Each of the plurality of tubes may include a plurality of inner fins inside the tube and centered about the midpoint in the length of the tube, the inner fins having ends spaced from the tube ends, and each of the resilient tube inserts may allow for the inner fins to extend at least partially therethrough in the direction of the tube end.

In another respect, the present invention is directed to a heat exchanger, comprising a header having a wall with a plurality of openings therein and a plurality of tubes interposed between a plurality of outer fins capable of transferring heat between a fluid passing through the plurality of tubes and the exterior of the outer fins. Each of the tubes extends beyond tops of the plurality of outer fins. Each of the tubes has a midpoint and a tube end secured in an opening in the wall of the header to form a tube-to-header joint. The distance between the top of the plurality of outer fins and the header is a free-of-fin area. The heat exchanger also includes a plurality of tube inserts having a substantially similar cross-section to the cross-section of the plurality of tubes. The tube inserts are slideably fit in one or more of the tubes at the tube end in the free-of-fin area, with each of the tube inserts secured in the free-of-fin area to enable the tube insert to remain in place during assembly of a heat exchanger. The heat exchanger further includes a tank connected to the header.

The plurality of tube inserts may be comprised of the same material as the plurality of tubes. Each of the plurality of tube inserts may or may not extend substantially past the free-of-fin area in the direction of the midpoint of the tube. Each of the plurality of tube inserts may have a length substantially equal to the distance from the end of the tube to the tops of the outer fins.

Each of the plurality of tube inserts may have a length and a portion of the material comprising the length of the tube insert may be removed beginning approximately at the top of the outer fins and extending in the direction of the midpoint of the tube. Alternatively, each of the tube inserts may include at least one tapered tooth extending approximately from the top of the outer fins and extending in the direction of the midpoint of the tube.

Each of the plurality of tubes may include a plurality of inner fins inside the tube and centered about the midpoint in the length of the tube, the inner fins having ends spaced from the tube ends, and each of the resilient tube inserts may allow for the inner fins to extend at least partially therethrough in the direction of the tube end for improved heat transfer and increased tube strength.

In another aspect, the present invention is directed to a method of assembling a core for a heat exchanger, comprising the steps of providing a header having a wall with a plurality of openings therein and providing a plurality of spaced-apart tubes having a midpoint and inner dimensions. Each of the tubes has a tube end capable of being secured in an opening in a wall of a header to form a tube-to-header joint. The method includes attaching a plurality of outer fins between the plurality of tubes and spaced a distance from each tube end, the plurality of outer fins being capable of transferring heat between a fluid passing through the plurality of tubes and the exterior of the outer fins. The method further includes inserting the plurality of tube ends into the openings in the wall of the header to form a tube-to-header joint, the tube-to-header joint being spaced a distance from the outer fin ends to form a free-of-fin area therebetween. The method also includes providing a plurality of resilient tube inserts. Each of the resilient tube inserts has a substantially similar cross-section to the cross-section of the plurality of tubes and is capable of being slideably fit in one or more of the tubes at the tube end and secured in the free-of-fin area. Each of the resilient tube inserts has outer dimensions slightly greater than the inner dimensions of each tube prior to insertion to enable the tube inserts to remain in place during assembly of a heat exchanger. The method further includes the step of inserting at least one resilient tube insert into at least one of the plurality of tubes at the tube end into the free-of-fin area.

The plurality of resilient tube inserts may be comprised of the same material as the plurality of tubes. The plurality of resilient tube inserts may be secured in the free-of-fin area by brazing during brazing of the heat exchanger assembly, or by soldering during solder baking of the heat exchanger assembly.

The resilient tube inserts may or may not extend substantially past the free-of-fin area in the direction of the midpoint of the tube. The plurality of resilient tube inserts may have a length substantially equal to the distance from the top of the plurality of fins to the end of the tubes.

Each of the plurality of resilient tube inserts may have a length and a portion of the material comprising the length of the tube insert may be removed beginning at the top of the outer fins and extending in the direction of the midpoint of the tube. Alternatively, each of the resilient tube inserts may include at least one tapered tooth beginning at the top of the outer fins and extending in the direction of the midpoint of the tube.

Each of the plurality of tubes may include a plurality of inner fins inside the tube and centered about the midpoint in the length of the tube, the inner fins having ends spaced from the tube ends, and each of the resilient tube inserts may allow for the inner fins to extend at least partially therethrough in the direction of the tube end for improved heat transfer and increased tube strength.

The method may further include providing a tank, and connecting the tank to the header to form a heat exchanger.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 depicts a front elevational view in the direction of cooling air flow of a typical heat exchanger assembly of the prior art;

FIG. 2A depicts a front elevational view of a portion of a typical heat exchanger assembly, partially sectioned, to show a header portion of an inlet tank, heat exchanger tubes sealed at tube-to-header joints, cooling fins and structural side pieces;

FIG. 2B depicts a cross-sectional view of a heat exchanger tube of FIG. 2A, taken along line A-A;

FIG. 3 depicts a front elevational sectional view of a magnified, cutaway view of a section of the header portion of FIG. 2A, showing one embodiment of the tube insert of the present invention inserted into a tube end at the tube-to-header joint and placed in the free-of-fin area;

FIG. 4A depicts a perspective view of one embodiment of the tube insert of the present invention;

FIG. 4B depicts a top plan view of a side of the tube insert of the present invention as shown in FIG. 4A;

FIG. 4C depicts a cross-sectional view of the tube insert of the present invention as shown in FIG. 4B, taken along line A-A;

FIG. 5A depicts an exploded perspective view of the tube insert of the present invention, as shown in FIGS. 4A-4C, and a heat exchanger core tube, prior to insertion of the tube insert into the tube end;

FIG. 5B depicts a cross-sectional view of the end of the tube insert of the present invention as shown in FIG. 5A, which has been inserted into the end of a heat exchanger core tube;

FIG. 6A depicts a perspective view of another embodiment of the tube insert of the present invention, showing both pieces of a two-piece insert;

FIG. 6B depicts a top plan view of the assembled two-piece tube insert of the present invention, as shown in FIG. 6A;

FIG. 6C depicts a cross-sectional view of the end of the assembled two-piece tube insert of the present invention as shown in FIG. 6B, taken along line A-A;

FIG. 7A depicts an exploded perspective view of the two-piece tube insert of the present invention, as shown in FIGS. 6A-6C, and a heat exchanger core tube, prior to insertion of the tube insert into the tube end; and

FIG. 7B depicts a cross-sectional view of the end of the two-piece tube insert of the present invention, as shown in FIG. 7A, which has been inserted into the end of a heat exchanger core tube.

FIG. 8A depicts a perspective view of yet another embodiment of the tube insert of the present invention;

FIG. 8B depicts a top plan view of the tube insert of the present invention as shown in FIG. 8A;

FIG. 8C depicts a cross-sectional view of the end of the tube insert of the present invention as shown in FIG. 8B, taken along line A-A;

FIG. 9A depicts an exploded perspective view of the tube insert of the present invention, as shown in FIGS. 8A-8C, and a heat exchanger core tube, prior to insertion of the tube insert into the tube end;

FIG. 9B depicts a cross-sectional view of the end of the tube insert of the present invention, as shown in FIG. 9A, which has been inserted into the end of a heat exchanger core tube;

FIG. 10A depicts a perspective view of another embodiment of the tube insert of the present invention;

FIG. 10B depicts a side elevational view of the tube insert of the present invention, as shown in FIG. 10A;

FIG. 10C depicts a cross-sectional view of the end of the tube insert of the present invention as shown in FIGS. 10A-10B, which has been inserted into the end of a heat exchanger core tube;

FIG. 11A depicts a front elevational sectional view in the direction of cooling air flow of a magnified, cutaway view of a section of a header portion of a heat exchanger, showing the embodiment of the tube insert of the present invention, as shown in FIGS. 10A-10C, inserted into a tube end at the tube-to-header joint and placed in the free-of-fin area;

FIG. 11B depicts a partially cutaway, side cross-sectional view in the direction transverse to cooling air flow of the section of the header, as shown in FIG. 11A;

FIG. 11C depicts a cross-sectional view of the heat exchanger core of FIG. 11A, taken along line A-A;

FIG. 12A depicts a perspective view of another embodiment of the tube insert of the present invention, showing both pieces of a two-piece insert;

FIG. 12B depicts a top plan view of the assembled two-piece tube insert of the present invention, as shown in FIG. 12A;

FIG. 12C depicts a cross-sectional view of the end of the assembled two-piece tube insert of the present invention as shown in FIG. 6B, taken along line A-A; and

FIG. 13 depicts a front elevational sectional view of a magnified, cutaway view of a section of a header portion of a heat exchanger, showing the embodiment of the tube insert of the present invention, as shown in FIGS. 12A-12C, inserted into a tube end at the tube-to-header joint and placed in the free-of-fin area.

### DESCRIPTION OF THE PREFERRED EMBODIMENT(S)

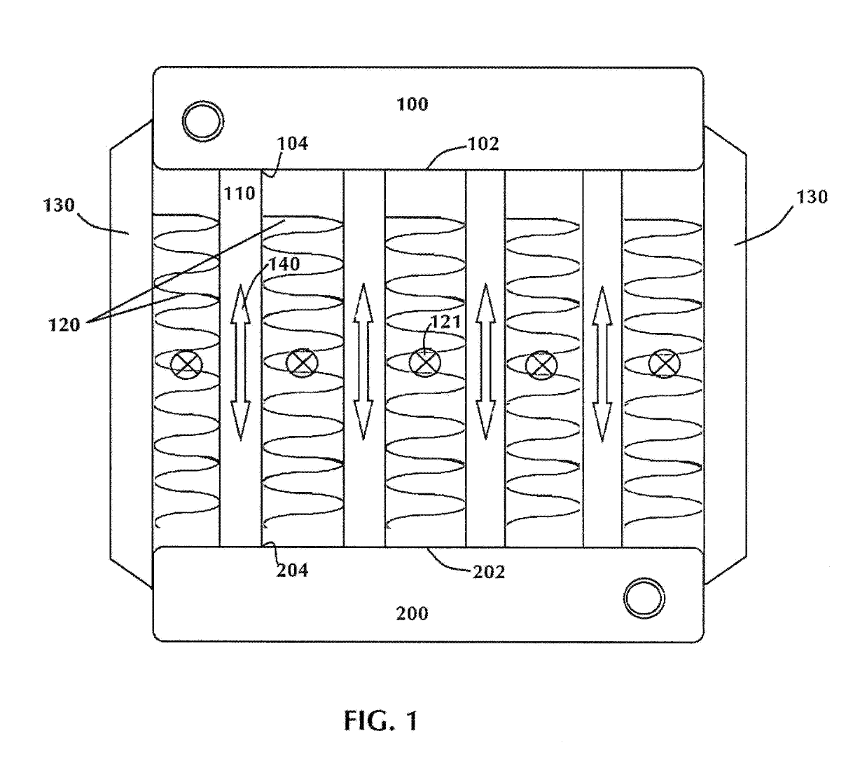

In describing the preferred embodiment of the present invention, reference will be made herein to FIGS. 1-13 of the drawings in which like numerals refer to like features of the invention.

Heat exchangers such as engine cooling radiators, charge air coolers, condensers, and the like, typically consist of an inlet tank (or manifold) and an outlet tank (or manifold); a core section between the tanks with inlet and outlet headers connected to the tanks and with multiple fluid tubes running from the inlet header to the outlet header, with cooling fins attached between the tubes; and structural side pieces, one on each side, connected to the inlet and outlet tanks. These side pieces often provide attachments for mounting the heat exchanger and further act to prevent the inlet and outlet tanks from moving during operation. The cooling fins are attached between the structural side pieces and the outermost tubes, as well as between adjacent tubes, and are positioned such that the fins are centered around a midpoint in the length of the fluid-carrying tubes, with a fin-free area adjacent the header portion of the inlet and outlet tanks. The region between the end of the cooling fins and the header is known as the “free-of-fin” area. The free-of-fin area begins where the cooling fins end.

During operation of the heat exchanger, heated fluid enters the inlet tank, flows through the core tubes to the outlet tank, and is cooled while passing through the tubes by cooling air passing over the fins. The heated fluid increases the temperature of the tubes, causing them to expand in length. When the system is shut down, the tubes cool and contract. This expansion and contraction of the tubes tries to increase and decrease the distance between the top and bottom headers, which are attached to the top and bottom tanks. However, the structural side pieces often restrain the tanks from moving, resulting in great stress at the tube-to-header joints as the expanding and contracting tubes try to move the immovable tanks. Due to the fact that there is some compliance in the headers, the stresses at the tube-to-header joints toward the center of the core are usually less than the stresses at the outermost tube-to-header joints, next to the structural side pieces. As a result of the expanding and contracting tubes trying to move the immovable tanks, the number one cause of failure of heat exchangers in service is failure of the outer tube-to-header joints or the tubes adjacent to these joints.

The present invention is directed to a tube insert which is inserted, either manually or through automation, into the end of a heat exchanger tube during assembly of a heat exchanger core to increase tube strength at the tube-to-header joint and in the free-of-fin area. After the header is fitted over the tube ends, the tube insert is placed inside the tube in the free-of-fin area from the point at the end of the tube where it enters the header to the point where the outer cooling fins end, and may be brazed or soldered in place during core brazing or solder baking. Preferably, the tube insert may be comprised of the same material as the core tubes, and acts to essentially increase the wall thickness of the tube in the area from the beginning of the free-of-fin area to the end of the tube. Tubes and fins in heat exchangers are typically made of aluminum or an aluminum alloy, and may be clad or coated with braze material, but other metals and alloys may also be used such as copper.

The present invention is applicable to many types of heat exchangers, however because the tubes of a charge air cooler (or intercooler) tend to be much larger in cross-section than those of radiators or condensers, the description used herein will primarily refer to application in a charge air cooler.

Certain terminology is used herein for convenience only and is not to be taken as a limitation of the invention. For example, words such as “upper,” “lower,” “left,” “right,” “horizontal,” “vertical,” “upward,” and “downward” merely describe the configuration shown in the drawings. For purposes of clarity, the same reference numbers may be used in the drawings to identify similar elements.

Referring now to FIG. 1, a typical heat exchanger assembly of the prior art is shown, with cooling air flow in direction 121 into or out of the page. The heat exchanger assembly consists of an inlet tank or manifold 100, an outlet tank or manifold 200, a plurality of fluid-carrying tubes 110 extending between the tanks or manifolds, and structural side pieces 130, one on either side, connected to both the inlet tank 100 and outlet tank 200. Headers 102, 202 are normally provided on the tanks for mechanical attachment and connection of the tubes to the tanks.

As shown in FIG. 1, a typical heat exchanger core is comprised of a plurality of vertical, parallel, spaced tubes 110, with extended outer surface fins 120 attached between them for transferring heat to passing airflow. Tubes 110 are inserted into, and sealed to, openings (not shown) in the walls of inlet header 102 and outlet header 202, respectively, to make up the core. The headers 102, 202 are connected to, or part of, the inlet and outlet tanks or manifolds 100, 200 and structural side pieces 130 connect the tanks to make the heat exchanger. Each of the tubes has a tube end secured in an opening in the header wall to form a tube-to-header joint 104, 204. Oval tubes are typically utilized for close tube spacing for optimum heat transfer performance of the heat exchanger, although other tube shapes and cross-sections may be utilized. As used herein, the term “oval” refers to any non-circular shaped axial cross-section (i.e. perpendicular to the axis of the tube) having a generally smoothly curving periphery, such as an ellipse or a rectangle with rounded corners, or other obround or egg shape.

In operation, heated fluid enters the inlet tank 100, flows through the core tubes 110 to the outlet tank 200, and is cooled while passing through the tubes 110 by cooling air passing over the outer fins 120. The heated fluid increases the temperature of the tubes 110, causing them to expand in length. When the system is shut down, the tubes 110 cool and contract. The thermal expansion and contraction of the tubes 110 is represented in FIG. 1 by arrows 140. This expansion and contraction of the tubes tries to increase and decrease the distance between the inlet and outlet headers and tanks. However, the structural side pieces 130 restrain the tanks from moving, resulting in great stress at the tube-to-header joints 104, 204 as the expanding and contracting tubes try to move the immovable tanks.

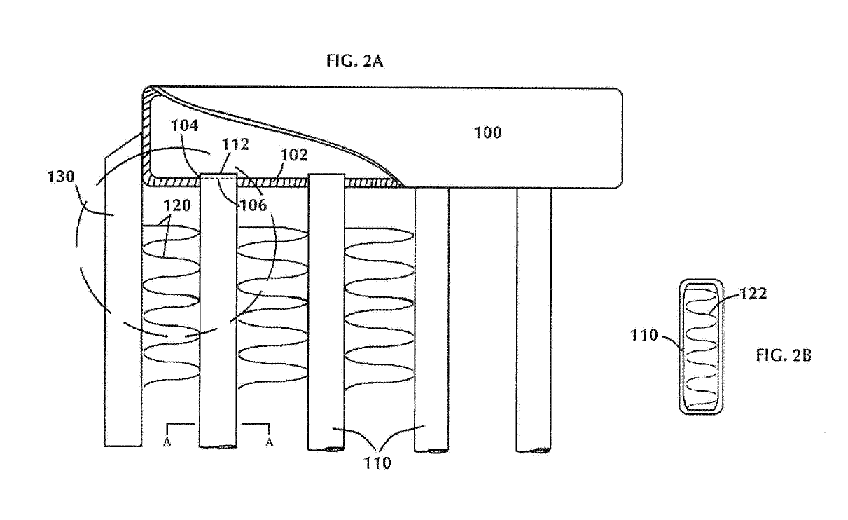

FIG. 2A shows a portion of a typical heat exchanger assembly, partially sectioned, to show the inlet header 102 attached to an inlet tank or manifold 100, with heat exchanger tubes 110 inserted into openings 106 in the header wall and sealed at tube-to-header joints 104. FIG. 2A further shows a structural side piece 130 with outer fins 120 between the structural side piece 130 and the outermost heat exchanger tube 110 and also between adjacent tubes 110. As shown in FIG. 2A, the cooling fins 120 are positioned such that the fins are centered around a midpoint of the fluid-carrying tubes, with a fin-free area adjacent the inlet header 102 attached to the inlet tank 100. FIG. 2B shows a cross-section of a heat exchanger tube 110 of FIG. 2A, taken along line A-A. As shown in FIG. 2B, tube 110 has a substantially oval cross-section and may include inner fins 122 extending along the length of the tube.

The outermost tube-to-header joint 104 is subject to repeated stress during operation of the heat exchanger, and therefore is at the greatest risk of failure. The present invention is directed to a tube insert which acts to increase the strength of the tube by adding reinforcing in the critical portion of the tube including the free-of-fin area along the tube between the point where the tube passes through, and is joined to, the header 102 and the tops of the outer fins 120.

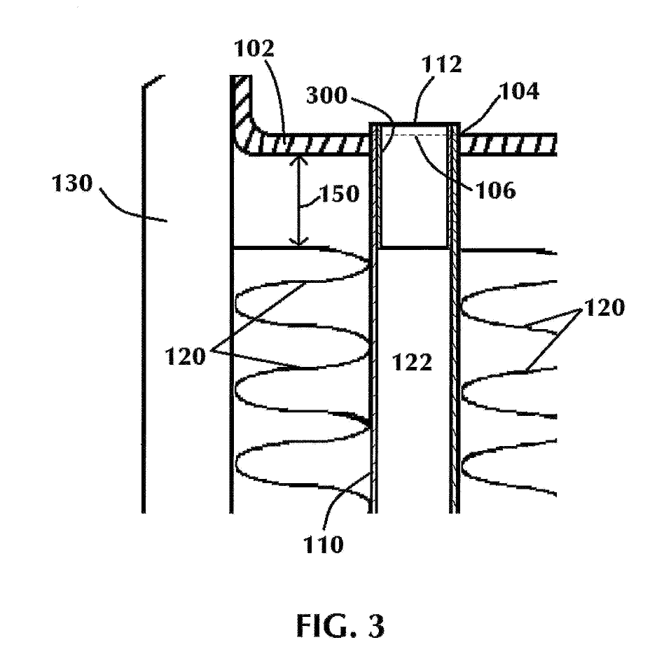

FIG. 3 depicts a magnified, cutaway view of a section of the header portion of FIG. 2A, showing one embodiment of the tube insert 300 of the present invention inserted into a tube end 112 and placed in the free-of-fin area 150. Tube 110 is inserted into an opening 106 in the wall of the header and sealed at tube-to-header joint 104. As shown in FIG. 3, the tube insert 300 has been inserted into tube 110 at tube end 112, and placed in the free-of-fin area 150 substantially between the tube-to-header joint 104 and the beginning of the outer fins 120. The tube insert may extend above the tube-to-header joint to the tube end 112. Tube insert 300 may be installed manually or by automation during assembly of the heat exchanger core, after the header is fitted over the tube ends. (Although the subsequent drawings herein may show the tube insert in relation to the tube end without showing the header, normally the tube end would be fitted into the header opening before the tube insert is fitted into the tube free-of-fin area.)

Tube insert 300 as shown does not extend past the free-of-fin area 150 in the direction of the midpoint of the tube and is placed in the region from the beginning of the free-of-fin area to the end 112 of the tube which has been inserted into the header wall opening. The length of tube insert 300 may be longer or shorter than the free-of-fin area in alternate embodiments, and/or substantially extends along the length of the free-of-fin area. As depicted in FIG. 3, tube insert 300 has been brazed in the free-of-fin area 150 during core brazing, but alternatively may be secured by soldering during solder baking of the core. By placing the tube insert substantially in the free-of-fin area, the tube insert acts to increase the wall thickness of the tube in this critical portion of the tube and where it passes through, and is joined to, the header. This increased thickness provides added strength at the tube-to-header joint, so that the joint can survive the high stresses associated with the repeated expansion and contraction of the core tubes due to temperature changes. Moreover, the amount of additional material required to fabricate the tube insert of the present invention is negligible over that of a standard heat exchanger core.

As shown in FIG. 3, tube insert 300 has been inserted in a tube adjacent to structural side piece 130, where stresses at the tube-to-header joint are typically greater. However, the tube insert of the present invention may also be utilized in tubes toward the center of the core, where stresses at the tube-to-header joint may be less due to potential compliance in the headers attached to the inlet and outlet tanks, as required to meet service life requirements.

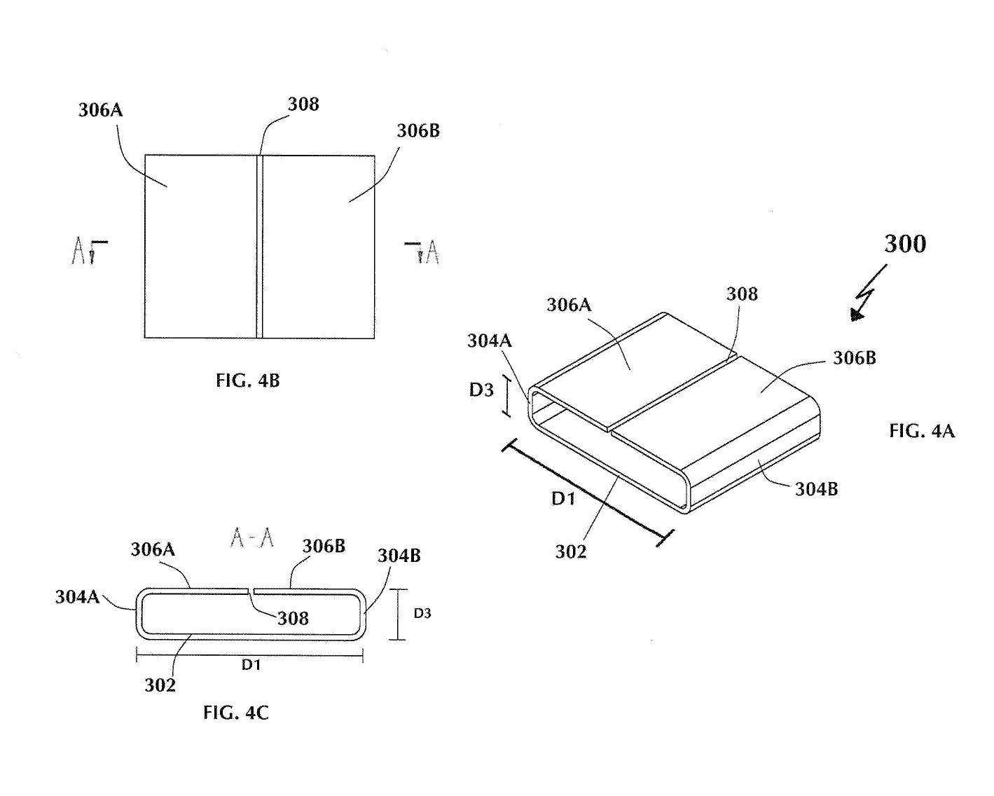

FIGS. 4A-4C depict one embodiment of the tube insert of the present invention. As shown in FIG. 4A, tube insert 300 may be a single piece insert formed from a flat sheet of resilient material, preferably the same material as the core tube into which the tube insert is to be inserted, which has a largely uniform surface and is folded to form a substantially oval cross-section having a major or large outer diameter or dimension D1 and a minor or small outer diameter or dimension D3. Tube insert 300 has an elongated flat bottom 302 and substantially perpendicular sides 304A, 304B spacing the elongated bottom 302 from top tabs 306A, 306B. Top tabs 306A, 306B form a plane substantially parallel to bottom 302 and approximately meet at a midpoint along the plane. Sides 304A, 304B and top tabs 306A, 306B may have an inherent elasticity such that they are capable of withstanding compression forces while retaining substantially the same shape.

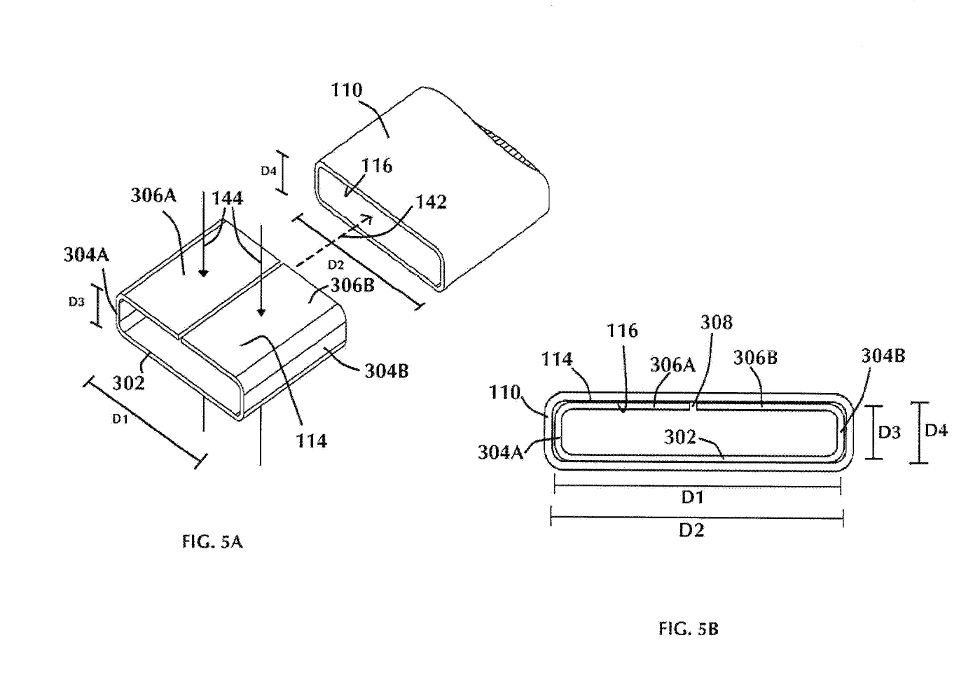

The distance between sides 304A, 304B determines the large dimension D1 of the tube insert and the height of sides 304A, 304B determines the small dimension D3. The respective dimensions are design dependent, per application requirements. As shown in FIGS. 5A-5B, preferably, dimension D1 is nominally smaller than the inner dimension D2 of the core tube into which the tube insert is to be inserted, to allow for a sliding fit. Further, tube insert small dimension D3 may be nominally larger than the inner dimension D4 of the core tube into which the tube insert is to be inserted, prior to insertion of the tube insert, to result in a tight, but sliding fit so that the insert will not fall out after being put in place. As tube insert 300 is inserted into the end of a tube in the direction of arrow 142, the exterior surface 114 of the tube insert 300 is subject to compression forces and is stressed so that it tends to urge the tube insert into tight engagement with the inner surface 116 of the tube upon insertion. The respective compression forces are shown in FIG. 5A by arrows 144. The inherent elasticity of the tube insert material acts as a “spring” feature allowing the tube insert to remain in place during processing of the heat exchanger core.

FIG. 4B shows a top plan view of tube insert 300. As shown in FIG. 4B, top tabs 306A, 306B do not meet and there remains a small gap 308 to allow for tabs 306A, 306B to move independently during insertion of the tube insert 300 into a heat exchanger core tube. As tube insert 300 is inserted into the end of a tube, tabs 306A, 306B may be subject to compression forces and stressed in a downward direction toward the center of the tube insert so as to urge the tube insert into tight engagement with the inner surface of the tube, as shown in FIGS. 5A-5B.

FIG. 4C shows a cross-sectional view of tube insert 300. As shown in FIG. 4C, tube insert 300 has a uniform cross-section with no protrusions which would block fluid flow through the tube and reduce heat transfer performance. Preferably, tube insert 300 is comprised of the same material as that of the core tube into which tube insert 300 is to be inserted. The thickness of tube insert 300 may be adjusted, as needed, to provide the required strength at the tube-to-header joint per application requirements.

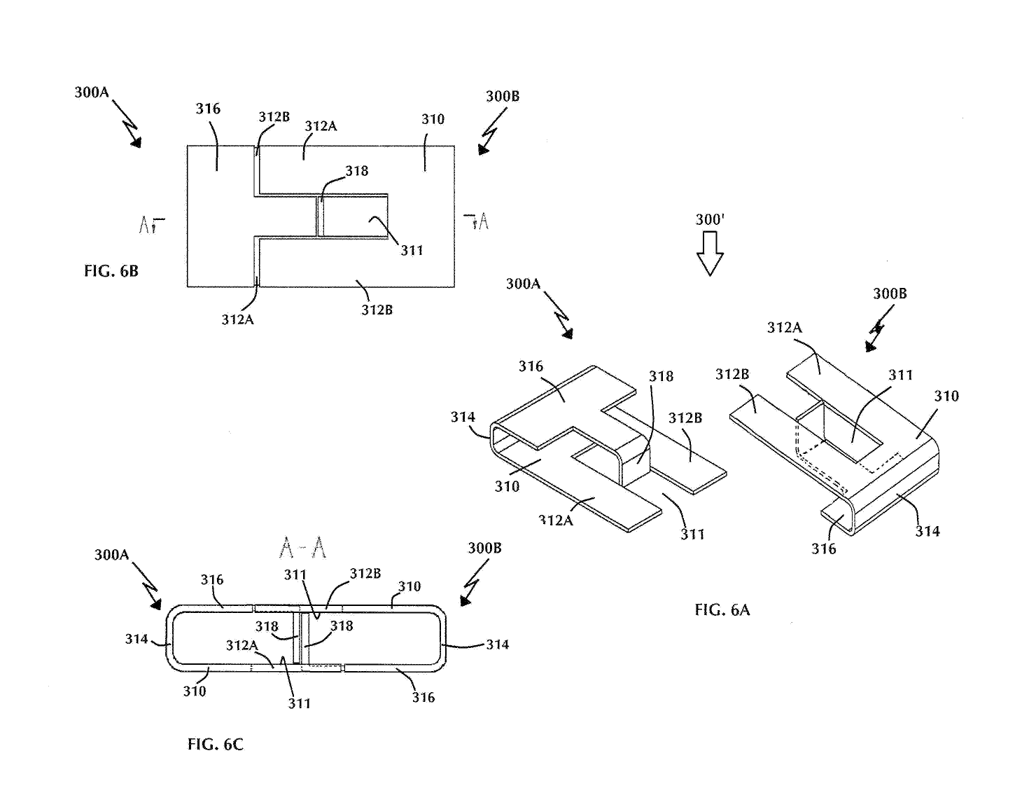

FIGS. 6A-6C depict another embodiment of the tube insert of the present invention. FIG. 6A shows both halves 300A, 300B of a two-piece tube insert 300′, wherein each half 300A, 300B of the two-piece insert is identically-shaped and configured to mate with the opposite half of the two-piece insert when either half is turned upside-down. Each tube insert half 300A, 300B includes a U-shaped flat bottom 310 having parallel legs 312A, 312B and a rectangular opening 311 interposed between legs 312A, 312B. Each tube insert half 300A, 300B further includes a side projection 314 disposed substantially perpendicular to bottom 310 and spacing flat bottom 310 from T-shaped top portion 316. Top portion 316 is substantially parallel to bottom portion 310 and includes a substantially perpendicular tab 318 disposed in the direction of a midpoint of bottom portion rectangular opening 311. Tab 318 does not extend beyond the plane formed by flat bottom parallel legs 312A, 312B.

Tube insert half 300A is mateable with structurally identical tube insert half 300B to form tube insert 300′, as shown in FIGS. 6B-6C. As depicted in FIGS. 6B-6C, to form the two-piece tube insert 300′ of the present invention, tube insert half 300B may be inverted and positioned such that bottom portion parallel legs 312A, 312B of tube insert half 300B form a plane with top portion 316 of tube insert half 300A, and bottom portion parallel legs 312A, 312B of tube insert half 300A form a plane with top portion 316 of tube insert half 300B. Tube insert half 300B is shown inverted, for exemplary purposes only, as the two piece insert 300′ could also be formed by instead inverting tube insert half 300A. Once assembled, tube insert 300′ has a substantially oval cross-section, as shown in FIG. 6C.

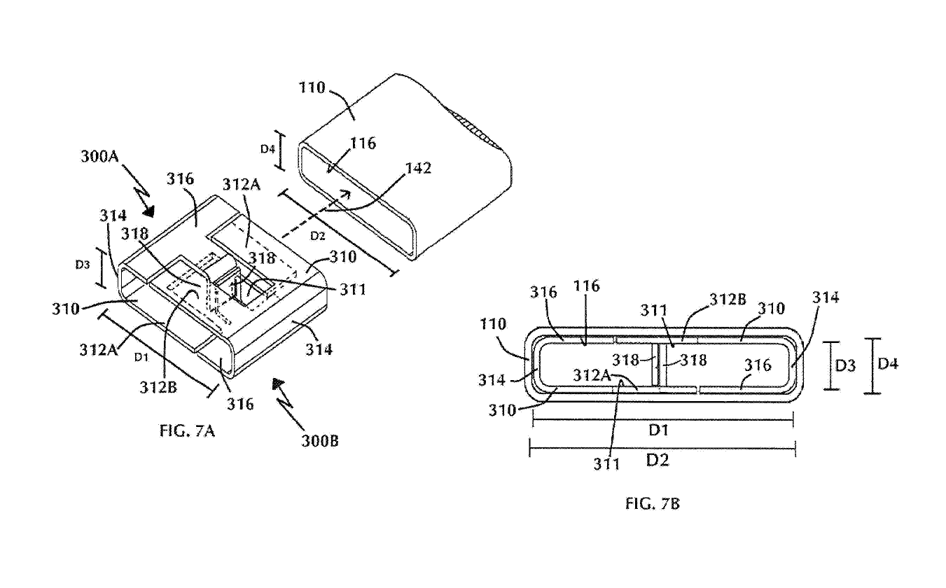

As depicted in FIGS. 7A-7B, once assembled, the two-piece tube insert 300′ has a major or large outer dimension D1 which is nominally smaller than the inner dimension D2 of the core tube into which the tube insert is to be inserted, to allow for a sliding fit. Further, tube insert minor or small outer dimension D3 may be nominally greater than the inner dimension D4 of the core tube into which the tube insert is to be inserted, prior to insertion of the tube insert, again to result in a tight, but sliding fit. As shown in FIGS. 7A-7B, as tube insert 300′ is inserted into the end of a tube in the direction of arrow 142, the exterior surface of the tube insert 300′ is stressed so that it tends to urge the tube insert into tight engagement with the inner surface 116 of the tube upon insertion. This allows tube insert 300′ to remain in place during processing of the heat exchanger core. Moreover, tube insert 300′ has a substantially similar cross-section to that of tube 110 into which it is inserted, providing for minimal interference with fluid flow from the header into the tube and, therefore, little or no impact on heat exchanger thermal performance.

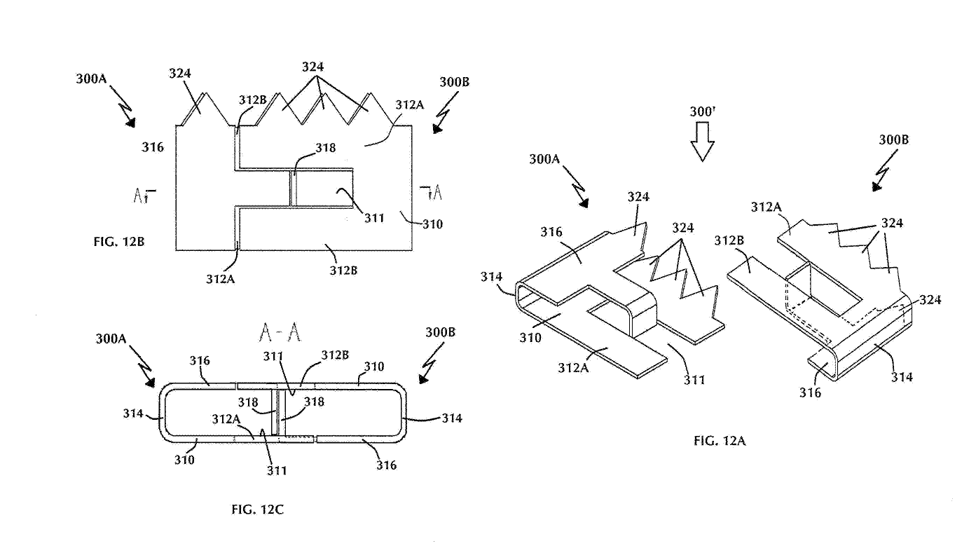

FIG. 6C shows a cross-sectional view of the two-piece tube insert 300′ of the present invention. When viewed in cross-section, tube insert 300′ is substantially oval, allowing for a tight, but sliding fit into an oval core tube, as shown in FIG. 7B. Other shapes of tube are not precluded, as the object of the present invention may be achieved so long as the cross-section of the tube and tube insert are substantially the same and the tube insert does not interfere with fluid flow in the tube or impact heat transfer performance. A modification of the embodiment depicted in FIGS. 6A-6C is shown in FIGS. 12A-12C.

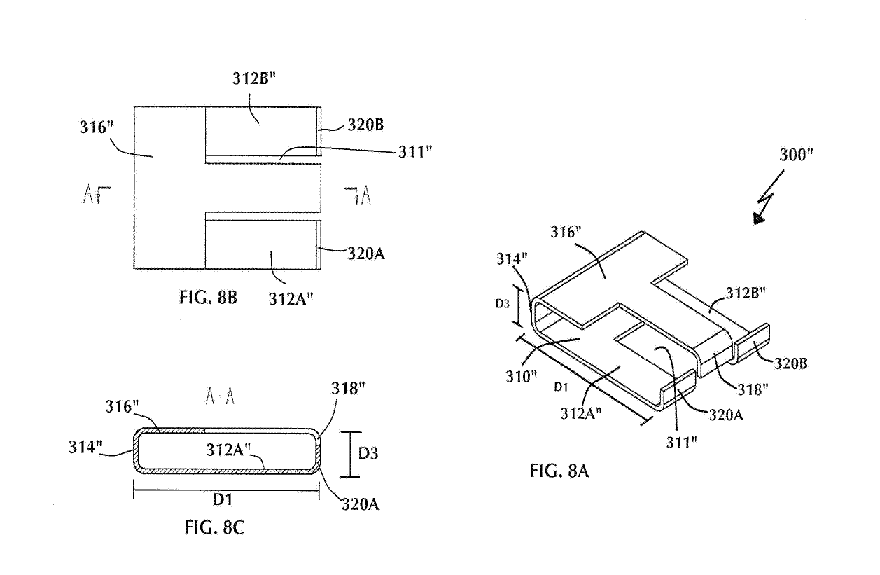

FIGS. 8A-8C depict yet another embodiment of the tube insert of the present invention, wherein tube insert 300″ is a single-piece insert having a non-uniform exterior surface. As shown in FIG. 8A, tube insert 300″ may be a single piece insert having a substantially oval cross-section with a major or large dimension D1 and a minor or small dimension D3, which may be formed from a flat sheet of resilient material, preferably the same material as the core tube into which the tube insert is to be inserted. Tube insert 300″ includes a U-shaped flat bottom 310″ having parallel legs 312A″, 312B″ and a rectangular opening 311″ interposed between legs 312A″, 312B″. Each leg 312A″, 312B″ further includes a vertical flap 320A, 320B disposed substantially perpendicular to bottom portion 310″ from the end of each leg 312A″, 312B″. Side projection 314″ is disposed substantially perpendicular from the opposite end of bottom portion 310″ and spaces bottom portion 310″ from T-shaped top portion 316″. Top portion 316″ is substantially parallel to bottom portion 310″ and includes a substantially perpendicular tab 318″ disposed in the direction of bottom portion rectangular opening 311″. Tab 318″ forms a plane with vertical flaps 320A, 320B and does not extend beyond the horizontal plane formed by bottom portion parallel legs 312A″, 312B″. Side projection 314″ may have an inherent elasticity such that the tube insert 300″ is capable of withstanding compression forces while retaining substantially the same shape.

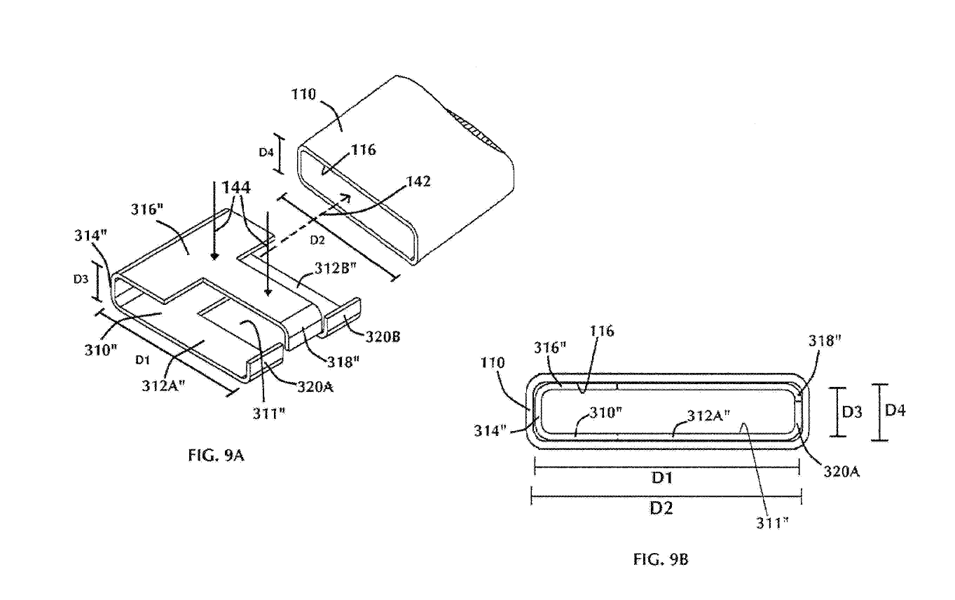

The distance between side projection 314″ and vertical flaps 320A, 320B determines the large dimension D1 of the tube insert and the height of side projection 314″ determines the small dimension D3. The respective dimensions D1, D3 are design dependent, per application requirements. As shown in FIGS. 9A-9B, preferably, tube insert dimension D1 is nominally smaller than the inner dimension D2 of the core tube into which the tube insert is to be inserted, to allow for a sliding fit. Moreover, tube insert dimension D3 may be greater than the inner dimension D4 of the core tube into which the tube insert is to be inserted, prior to insertion of the tube insert, to achieve the tight but sliding fit. As further shown in FIGS. 9A-9B, as tube insert 300″ is inserted into the end of a tube in the direction of arrow 142, the top portion 316″ of the tube insert 300″ is subject to compression forces and is stressed so that it tends to urge the tube insert into tight engagement with the inner surface 116 of the tube upon insertion. The respective compression forces are shown in FIG. 9A by arrows 144. The inherent elasticity of the tube insert acts as a “spring” feature allowing the tube insert to remain in place during processing of the heat exchanger core.

FIG. 8B shows a top plan view of tube insert 300″. As shown in FIG. 8B, vertical flaps 320A, 320B form a plane with tab 318″ (not shown) which protrudes from the edge of T-shaped top portion 316″ in the direction of rectangular opening 311″. Parallel legs 312A″, 312B″ may move independently from top portion 316″ so as to urge the tube insert 300″ into tight engagement with the inner surface of the tube upon insertion. As tube insert 300″ is inserted into the end of a tube, top portion 316″ may be subject to compression forces and stressed in a downward direction toward parallel legs 312A″, 312B″ so as to urge the tube insert into tight engagement with the inner surface of the tube, as shown in FIGS. 9A-9B.

FIG. 8C shows a cross-sectional view of tube insert 300″. As shown in FIG. 8C, tube insert 300″ has a uniform, substantially oval cross-section with no protrusions which would block fluid flow through the tube and reduce heat transfer performance. Additionally, the thickness of tube insert 300″ may be adjusted, as needed, to provide the required strength at the tube-to-header joint per application requirements.

As shown in FIGS. 3, 11A, 11B and 13, the free-of-fin area is considered to begin at the tops of the outer cooling fins and extends to the header. In providing inner reinforcement to the tube, the tube insert of the present invention may extend from the end of the tube to beyond the tube-to-header joint, at least as far as the beginning of the free-of-fin area (in other words, where the cooling fins end). To avoid a stress concentration at what would be a radical change of stiffness point (which would increase the possibility of tube failure in the free-of-fin area), it is preferable for the tube insert of the present invention to extend into the portion of the tube which is supported by outer cooling fins, with a gradual reduction in the stiffness of the tube insert in the portion of the tube insert which extends beyond the beginning of the free-of-fin area in the direction of the midpoint in the length of the tube, thereby providing a constant strain stiffness distribution in this critical area.

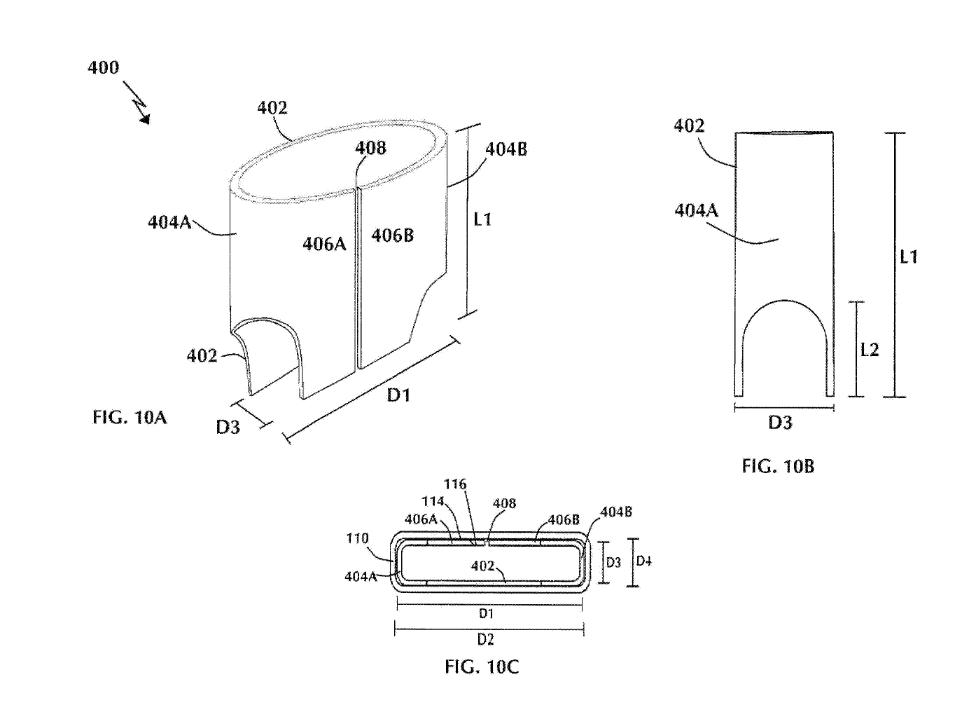

FIGS. 10A-10C depict another embodiment of the tube insert of the present invention, which provides for a gradual reduction in stiffness as the tube insert enters the portion of the tube which is supported by the outer fins. Similar to tube insert 300, as shown in FIG. 4A, tube insert 400 may again be a single piece insert formed from a flat sheet of resilient material, preferably the same material as the core tube into which the tube insert is to be inserted, which has a largely uniform surface and is folded to form a substantially oval cross-section having a major or large outer dimension D1, a minor or small outer dimension D3, and a major length L1. Tube insert 400 has an elongated flat bottom 402 and substantially perpendicular sides 404A, 404B spacing the elongated bottom 402 from top tabs 406A, 406B. Top tabs 406A, 406B form a plane substantially parallel to bottom 402 and approximately meet at a midpoint along the plane. Sides 404A, 404B and top tabs 406A, 406B may have an inherent elasticity such that they are capable of withstanding compression forces while retaining substantially the same shape.

The distance between sides 404A, 404B determines the large dimension D1 of the tube insert and the height of sides 304A, 304B determines the small dimension D3. The respective dimensions are design dependent, per application requirements. As shown in FIG. 10C, preferably, dimension D1 is nominally smaller than the inner dimension D2 of the core tube 110 into which the tube insert is to be inserted, to allow for a sliding fit. Further, tube insert small dimension D3 may be nominally larger than the inner dimension D4 of the core tube 110 into which the tube insert is to be inserted, prior to insertion of the tube insert, to result in a tight, but sliding fit so that the tube insert will not fall out after being put in place. As tube insert 400 is inserted into the end of a tube, the exterior surface 114 of the tube insert 400 is subject to compression forces and is stressed so that it tends to urge the tube insert into tight engagement with the inner surface 116 of the tube upon insertion. The inherent elasticity of the tube insert material acts as a “spring” feature allowing the tube insert to remain in place during processing of the heat exchanger core.

As further shown in FIG. 10A, top tabs 406A, 406B do not meet and there remains a small gap 408 to allow for tabs 406A, 406B to move independently during insertion of the tube insert 400 into a heat exchanger core tube. As shown in FIG. 10C, as tube insert 400 is inserted into the end of a tube 110, tabs 406A, 406B may be subject to compression forces and stressed in a downward direction toward the center of the tube insert so as to urge the tube insert into tight engagement with the inner surface 116 of the tube.

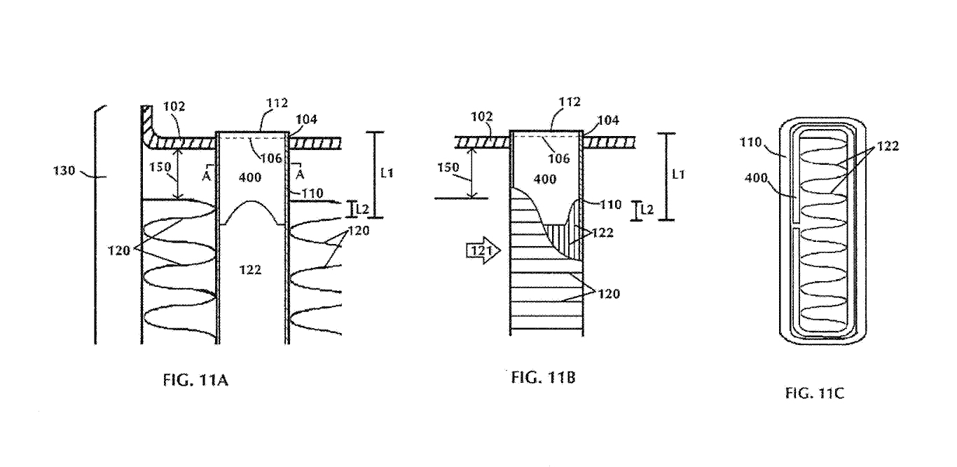

FIG. 10B shows a side elevational view of tube insert 400. As shown in FIG. 10B, a length L2 of a portion of the material comprising the major length L1 of tube insert 400 has been removed on each of sides 404A, 404B. When tube insert 400 is inserted into a heat exchanger tube and placed in the free-of-fin area, length L2 extends into the portion of the tube which is supported by outer fins. The removal of material along length L2 of tube insert 400 provides for a gradual reduction in stiffness in the region where the support from outer fins ends and the free-of-fin area begins, thereby avoiding a stress concentration at what would otherwise be a radical change of stiffness point, as shown in FIGS. 11A-11B.

FIGS. 11A and 11B show a magnified elevational view in the direction of cooling air flow, and a side cross-sectional, partially cutaway view in a direction transverse to cooling air flow, respectively, of a section of a header portion of a heat exchanger, including tube insert 400, as shown in FIGS. 10A-10C. The direction of cooling air flow is shown in FIG. 11B by arrow 121. Tube 110 is inserted into an opening 106 in the wall of the header 102 and sealed at tube-to-header joint 104. As shown in FIGS. 11A-11B, tube insert 400 has been inserted into tube 110 at tube end 112, and placed substantially between the tube end 112 and the beginning of free-of-fin area 150. Tube insert 400 may be installed manually or by automation during assembly of the heat exchanger core after the tube end is inserted into the header opening. Moreover, the thickness of tube insert 400 may be adjusted, as needed, to provide the required strength at the tube-to-header joint per application requirements.

As shown in FIGS. 11A-11B, the major length L1 of tube insert 400 may extend past the beginning of the free-of-fin area and into the portion of the tube supported by inner fins 122 and outer fins 120. As shown, a plurality of inner fins 122 may be centered about a midpoint in the length of the interior of tube 110 and extend along the length of tube 110 in the direction of header 102. Inner fins 122 provide additional support for tube 110 and improve heat transfer performance. The distance tube insert 400 extends past the beginning of the free-of-fin area is substantially equal to the length L2 of the portion of the material that has been removed from tube insert 400. The removal of material in this portion of tube insert 400 allows for a gradual reduction in stiffness along the length of the tube in the region where the support from outer fins ends and the free-of-fin area begins, thereby avoiding a stress concentration at what would otherwise be a radical change of stiffness point and decreasing the likelihood of tube failure in this region.

As depicted in FIG. 11A, tube insert 400 has been brazed in the free-of-fin area 150 during core brazing, but alternatively may be secured by soldering during solder baking of the core. By placing the tube insert substantially in the free-of-fin area, the tube insert acts to increase the wall thickness and strength of the tube in this critical portion of the tube and where it passes through, and is joined to, the header. This increased thickness provides added strength at the tube-to-header joint, so that the joint can survive the high stresses associated with the repeated expansion and contraction of the core tubes due to temperature changes. Moreover, the amount of additional material required to fabricate the tube insert of the present invention is negligible over that of a standard heat exchanger core.

FIG. 11C shows a cross-sectional view of the heat exchanger core of FIG. 11A, taken along line A-A. As shown in FIG. 11C, tube insert 400 has a substantially similar cross-section to tube 110 to allow for a tight, but sliding fit, during placement of the tube insert and during subsequent brazing or solder baking of the heat exchanger core. As depicted in FIGS. 11A-11B, and more particularly shown in FIG. 11C, tube insert 400 has a substantially uniform, oval cross-section allowing for internal fins 122 to extend at least partially therethrough in the direction of the tube end for improved heat transfer and increased tube strength.

FIGS. 12A-12C depict a modification of the two-piece tube insert shown in FIGS. 6A-6C, wherein a portion of the length of the two-piece tube insert extends into the section of the tube which is supported by the outer fins, providing for a gradual reduction in stiffness. As shown in FIGS. 12A-12B, each half 300A, 300B of two-piece tube insert 300′ may further include tapered teeth 324 extending perpendicular to, and along the plane formed by, parallel legs 312A, 312B, as well as at least one tapered tooth 324 extending perpendicular to, and along the plane formed by, top portion 316. As shown in FIG. 12B, when halves 300A, 300B are mated to form two-piece tube insert 300′, all tapered teeth 324 extend in the same direction and the tapered teeth 324 extending from top portion 316 are spaced from and parallel to the tapered teeth 324 extending from legs 312A, 312B. As further shown in FIG. 12C, the cross-section of tube insert 300′ remains substantially oval, allowing for a tight, but sliding fit into an oval core tube.

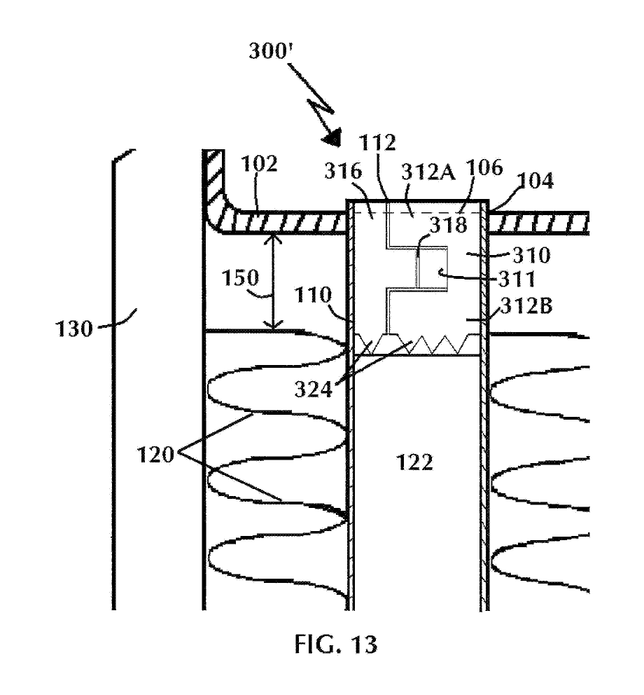

FIG. 13 shows a magnified, cutaway view of a section of a header portion of a heat exchanger, including tube insert 300′ with tapered teeth 324, as shown in FIGS. 12A-12C. Tube 110 is inserted into an opening 106 in the wall of the header 102 and sealed at tube-to-header joint 104. As shown in FIG. 13, tube insert 300′ has been inserted into tube 110 at tube end 112, and placed substantially between the tube end 112 and the beginning of free-of-fin area 150. Tube insert 300′ may be installed manually or by automation during assembly of the heat exchanger core after the header is in place over the tube ends. Moreover, the thickness of tube insert 300′ may be adjusted, as needed, to provide the required strength at the tube-to-header joint per application requirements.

As shown in FIG. 13, tube insert 300′ is placed such that tapered teeth 324 extend from the beginning of the free-of-fin area and into the portion of the tube supported by outer fins 120. Tapered teeth 324 extend beyond the beginning of the free-of-fin area 150 so that there is not an abrupt change in the strength of the tube 110 at the juncture of where the support from outer fins 120 ends and the free-of-fin area 150 begins, thereby avoiding a stress concentration at what would otherwise be a radical change of stiffness point and decreasing the likelihood of tube failure in this region. As shown, a plurality of inner fins 122 may be centered about a midpoint in the length of the interior of tube 110 and extend along the length of tube 110 in the direction of header 102. Inner fins 122 provide additional support for tube 110 and improve heat transfer performance. As shown in FIG. 13, the tapered teeth 324 end where inner fins 122 end; however, tube insert 300′ includes a substantially uniform cross-section allowing for internal fins 122 to extend at least partially therethrough in the direction of the tube end for improved heat transfer and increased tube strength. In assembling the heat exchanger core, the inner fins may be inserted into the tubes before or after the header is placed over the tube end, and the tube inserts may be inserted into the free-of-fin area after the header is placed over the tube end so that there is no outward force on the tube ends as the header is fitted.

As depicted in FIG. 13, tube insert 300′ has been brazed in the free-of-fin area 150 during core brazing, but alternatively may be secured by soldering during solder baking of the core. By placing the tube insert 300′ substantially in the free-of-fin area, the tube insert acts to increase the wall thickness of the tube in this critical portion of the tube and where it passes through, and is joined to, the header. This increased thickness provides added strength at the tube-to-header joint, so that the joint can survive the high stresses associated with the repeated expansion and contraction of the core tubes due to temperature changes. Moreover, the amount of additional material required to fabricate the tube insert of the present invention is negligible over that of a standard heat exchanger core.

Those skilled in the art should appreciate that the shapes of the tube insert of the present invention depicted in the Figures are shown for exemplary purposes only, and that many other shapes having the same inventive features may be used to carry out the same purposes of the present invention, so long as the tube insert has a substantially similar cross-section to that of the core tube and may be inserted into the end of a core tube to provide increased strength at the tube-to-header joint, while preserving an almost un-measurable increase in fluid pressure drop through the heat exchanger core and having little or no impact on heat exchanger thermal performance.

Thus the present invention achieves one or more of the following advantages. The tube insert may be installed manually or through automation, which provides added strength to a tube in the critical portion of the tube including the free-of-fin area and where it passes through, and is joined to, the header. The tube insert provides a constant strain stiffness distribution in the critical juncture between the free-of-fin area and where the tube is supported by outer cooling fins, and includes a spring feature to allow the tube insert to remain in place during core processing. The thickness of the tube insert can be adjusted as desired to provide the necessary tube joint strength to meet application requirements. The tube insert can be applied to the ends of a tube nearest to the structural side pieces or to several tubes, as required to meet service life requirements. It requires a negligible amount of additional material over that of a standard heat exchanger, and results in substantially no increase in fluid pressure drop through the heat exchanger core and therefore has little or no impact on heat exchanger thermal performance.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A core for a heat exchanger, comprising:
a header having a wall with a plurality of openings therein;
a plurality of spaced-apart tubes having a length with a midpoint in the length of the tube and an inner cross-section dimension, each of the tubes having a tube end secured in an opening in the wall of the header to form a tube-to-header joint;
a plurality of outer fins attached between the plurality of tubes and centered about the midpoint in the length of the tubes, the outer fins having ends spaced from the tube-to-header joint to form a free-of-fin area extending therebetween, the plurality of outer fins capable of transferring heat between a fluid passing through the plurality of tubes and the exterior of the outer fins; and
a plurality of resilient tube inserts having a substantially similar cross-section to the cross-section of the plurality of tubes, each of the resilient tube inserts inserted into one or more of the tubes at the tube end and secured substantially in the free-of-fin area, each of the resilient tube inserts having an outer cross-section dimension greater than the inner cross-section dimension of each tube prior to insertion to enable the tube inserts to remain in place in the free-of-fin area during assembly of a heat exchanger.

2. The heat exchanger core of claim 1 wherein the plurality of resilient tube inserts are comprised of the same material as the plurality of tubes.

3. The heat exchanger core of claim 1 wherein the resilient tube insert does not extend substantially past the free-of-fin area in the direction of the midpoint of the tube length.

4. The heat exchanger core of claim 1 wherein the resilient tube insert extends past the free-of-fin area in the direction of the midpoint of the tube length.

5. The heat exchanger core of claim 1 wherein each of the plurality of resilient tube inserts has a length and a portion of the material comprising the length of the resilient tube insert is removed beginning at the end of the outer fins and extending in the direction of the midpoint of the tube length.

6. The heat exchanger core of claim 1 wherein each of the resilient tube inserts includes at least one tapered tooth beginning at the end of the outer fins and extending in the direction of the midpoint of the tube length.

7. The heat exchanger core of claim 1 wherein each of the plurality of tubes includes a plurality of inner fins inside the tube and centered about the midpoint in the length of the tube, the inner fins having ends spaced from the tube ends, and wherein each of the resilient tube inserts allows for the inner fins to extend at least partially therethrough in the direction of the tube end.

8. A heat exchanger, comprising:
a header having a wall with a plurality of openings therein;
a plurality of tubes interposed between a plurality of outer fins capable of transferring heat between a fluid passing through the plurality of tubes and the exterior of the outer fins, each of the tubes extending beyond tops of the plurality of outer fins, each of the tubes having a length with a midpoint in the length of the tube and having a tube end secured in an opening in the wall of the header to form a tube-to-header joint, the distance between the top of the plurality of outer fins and the header being a free-of-fin area;
a plurality of tube inserts having a substantially similar cross-section to the cross-section of the plurality of tubes, the tube inserts being slideably fit in one or more of the tubes at the tube end in the free-of-fin area, each of the tube inserts secured in the free-of-fin area to enable the tube insert to remain in place during assembly of a heat exchanger; and
a tank connected to the header.

9. The heat exchanger of claim 8 wherein the plurality of tube inserts are comprised of the same material as the plurality of tubes.

10. The heat exchanger of claim 8 wherein the tube inserts do not extend substantially past the free-of-fin area in the direction of the midpoint of the tube length.

11. The heat exchanger of claim 8 wherein the tube insert extends past the free-of-fin area in the direction of the midpoint of the tube length.

12. The heat exchanger of claim 8 wherein each of the plurality of tube inserts has a length and a portion of the material comprising the length of the tube insert is removed beginning at the top of the outer fins and extending in the direction of the midpoint of the tube length.

13. The heat exchanger of claim 8 wherein each of the tube inserts includes at least one tapered tooth extending from the top of the outer fins and extending in the direction of the midpoint of the tube length.

14. The heat exchanger of claim 8 wherein each of the plurality of tubes includes a plurality of inner fins inside the tube and centered about the midpoint in the length of the tube, the inner fins having ends spaced from the tube ends, and wherein each of the resilient tube inserts allows for the inner fins to extend at least partially therethrough in the direction of the tube end for improved heat transfer and increased tube strength.

15. A method of assembling a core for a heat exchanger, comprising the steps of:
providing a header having a wall with a plurality of openings therein;
providing a plurality of spaced-apart tubes having a length with a midpoint in the length of the tube and an inner cross-section dimension, each of the tubes having a tube end capable of being secured in an opening in a wall of a header to form a tube-to-header joint;
attaching a plurality of outer fins between the plurality of tubes and having outer fin ends spaced a distance from each tube end, the plurality of outer fins capable of transferring heat between a fluid passing through the plurality of tubes and the exterior of the outer fins;
providing a plurality of resilient tube inserts, each of the resilient tube inserts having a substantially similar cross-section to the cross-section of the plurality of tubes and capable of being slideably fit in one or more of the tubes at the tube end, each of the resilient tube inserts having an outer cross-section dimension greater than the inner cross-section dimension of each tube prior to insertion to enable the tube inserts to remain in place during assembly of a heat exchanger;
inserting the plurality of tube ends into the openings in the wall of the header to form a tube-to-header joint, the tube-to-header joint spaced a distance from the outer fin ends to form a free-of-fin area therebetween, and
inserting at least one resilient tube insert into at least one of the plurality of tubes at the tube end into the free-of-fin area.

16. The method of claim 15 wherein the plurality of resilient tube inserts are comprised of the same material as the plurality of tubes.

17. The method of claim 15 wherein the plurality of resilient tube inserts are secured in the free-of-fin area by brazing during brazing of the heat exchanger assembly.

18. The method of claim 15 wherein the plurality of resilient tube inserts are secured in the free-of-fin area by soldering during solder baking of the heat exchanger assembly.

19. The method of claim 15 wherein the resilient tube insert does not extend substantially past the free-of-fin area in the direction of the midpoint of the tube length.

20. The method of claim 15 wherein each of the resilient tube insert extends past the free-of-fin area in the direction of the midpoint of the tube length.

21. The method of claim 15 wherein each of the plurality of resilient tube inserts has a length and a portion of the material comprising the length of the tube insert is removed beginning at the top of the outer fins and extending in the direction of the midpoint of the tube length.

22. The method of claim 15 wherein each of the resilient tube inserts includes at least one tapered tooth beginning at the top of the outer fins and extending in the direction of the midpoint of the tube length.

23. The method of claim 15 wherein each of the plurality of tubes includes a plurality of inner fins inside the tube and centered about the midpoint in the length of the tube, the inner fins having ends spaced from the tube ends, and wherein each of the resilient tube inserts allows for the inner fins to extend at least partially therethrough in the direction of the tube end for improved heat transfer and increased tube strength.

24. The method of claim 15 further including providing a tank, and connecting the tank to the header to form a heat exchanger.
